(19) United States
(12) Patent Application Publication
(10) Pub. No.: US 2017/0105146 A1
(43) Pub. Date: Apr. 13, 2017

(54) RESOURCE RESERVATION METHOD AND APPARATUS, ACCESS POINT, AND NETWORK SERVER

(71) Applicant: HUAWEI TECHNOLOGIES CO., LTD., Shenzhen (CN)

(72) Inventors: Guangzhu ZENG, Hangzhou (CN); Yong XIE, Chengdu (CN); Jun CHEN, Beijing (CN)

(73) Assignee: HUAWEI TECHNOLOGIES CO., LTD., Shenzhen (CN)

(21) Appl. No.: 15/388,087

(22) Filed: Dec. 22, 2016

Related U.S. Application Data
(63) Continuation of application No. PCT/CN2014/080699, filed on Jun. 25, 2014.

(51) Int. Cl. H04W 28/26; H04W 64/00; H04W 36/08

(52) U.S. Cl. CPC H04W 28/26; H04W 36/08; H04W 64/00; H04W 88/08

(57) ABSTRACT

The present disclosure proposes a user resource reservation method and apparatus, an access point, and a network server. The user resource reservation method includes: predicting a next access point that is to be reached by a user; and sending resource reservation designating information to the access point, so that the access point reserves a resource for the user according to the resource reservation designating information. In embodiments of the present disclosure, a next access point that is to be reached by a user is predicted and the access point is instructed to reserve a resource for the user, that is, a next access point is instructed in advance to reserve an appropriate resource for the user, so that the user is successfully handed over to a network, and a probability of successful handover of the user to the network increases, thereby improving user experience.

### CROSS-REFERENCE TO RELATED APPLICATIONS

This application is a continuation of International Application No. PCT/CN2014/080699, filed on Jun. 25, 2014, the disclosure of which is hereby incorporated by reference in its entirety.

### TECHNICAL FIELD

The present disclosure relates to network technologies, and in particular, to a user resource reservation method and apparatus, an access point, and a network server.

### BACKGROUND

With vigorous development of the Internet, people use wireless communications 2G, 3G, and 4G networks to transmit more service data. A small quantity of multimedia messaging services and a small quantity of Internet access services at the beginning gradually evolve to a large quantity of Internet access services, a large amount of voice data, a large amount of video data, a large amount of mobile phone game data, and the like. In the future, this trend may be more rapidly evolved, and countless wireless terminal users, M2M devices, and Internet of Vehicles devices access the Internet by using a wireless mobile communications network. However, a large amount of traffic may cause severe congestion of network transmission.

To resolve a network congestion problem, in the prior art, a technical solution that a network resource is reserved for a user is proposed. That is, when a network side receives a request of reserving a resource for the user on a target transmission path, the resource is reserved for the user before the user switches the network, so that the user can successfully switch the network in a moving process.

The inventor of the present disclosure finds that, in an existing implementation manner of reserving a resource, a network server may successfully reserve the resource for the user when the network resource is sufficient. However, when the network resource is congested, generally the resource cannot be successfully reserved for the user, which cannot ensure that the user is successfully handed over to the network, degrading user experience.

### SUMMARY

Embodiments of the present disclosure provide a user resource reservation method and apparatus, an access point, and a network server, to resolve a problem in the prior art that a communication service with quality assurance cannot be provided for an important user when a network resource is congested.

To resolve the foregoing technical problem, the embodiments of the present disclosure disclose the following technical solutions:

A first aspect provides a user resource reservation apparatus, including:

a prediction unit, configured to predict a next access point that is to be reached by a user; and

a resource control unit, configured to send resource reservation designating information to the access point, so that the access point reserves a resource for the user according to the resource reservation designating information.

In a first possible implementation manner of the first aspect, the prediction unit is further configured to:

obtain a resource reservation request message sent by the user, where the resource reservation request message includes location information; and

predict, according to the location information, the next access point that is to be reached by the user.

With reference to the first aspect or the first possible implementation manner of the first aspect, in a second possible implementation manner, further including: the obtaining unit is further configured to obtain information about a navigation path and a motion status that are of the user.

With reference to the first aspect or the first or the second possible implementation manner of the first aspect, in a third possible implementation manner, the apparatus further includes:

a judging unit, configured to determine a priority of the user when the obtaining unit obtains the resource reservation request message; and

a determining unit, configured to determine, according to a busy/idle state of the resource and the priority of the user that is determined by the judging unit, to reserve a resource for the user; where

the prediction unit is further configured to: when the determining unit determines to reserve the resource for the user, predict the next access point that is to be reached by the user.

With reference to the first aspect or the first, second, or the third possible implementation manner of the first aspect, in a fourth possible implementation manner, the resource reservation request message obtained by the obtaining unit further includes: navigation route information, a resource reservation quantity, and effective time of resource reservation.

With reference to the first aspect or the first, the second, the third, or the fourth possible implementation manner of the first aspect, in a fifth possible implementation manner, the resource reservation designating information sent by the resource control unit includes: a user identifier and a priority of resource reservation.

A second aspect provides a user resource reservation apparatus, including:

a receiving unit, configured to receive user resource reservation designating information; and

a resource reservation unit, configured to reserve a resource for the user according to the user resource reservation designating information; and when a network resource is congested, smoothly remove some users from a network service or reduce bandwidth used by some users.

In a first possible implementation manner of the second aspect, the resource reservation designating information received by the receiving unit includes: a user identifier and a priority of resource reservation.

With reference to the second aspect or the first possible implementation manner of the second aspect, in a second possible implementation manner, the receiving unit is further configured to receive a handover request of the user; and the apparatus further includes:

a resource allocation unit, configured to: when the resource is reserved for the user, allocate, according to the handover request received by the receiving unit, the resource reserved for the user to the user.

A third aspect provides a user resource reservation apparatus, including:

a navigation unit, configured to obtain start-end location information of navigation and current location information of a user; and

a wireless communications unit, configured to send, to a network server, the start-end location information of the navigation obtained by the navigation unit and the current location information of the user obtained by the navigation unit, so that the network server instructs, according to the start-end location information of the navigation and the current location information of the user, an access point on a navigation path to reserve a resource for the user.

In a first possible implementation manner of the third aspect, the wireless communications unit is further configured to: before navigation for the user, send a resource reservation request message to the network server, where the resource reservation request message includes the start-end location information of the navigation; and receive a resource reservation acknowledgement response message that is fed back by the network server.

With reference to the third aspect or the first possible implementation manner of the third aspect, in a second possible implementation manner, the resource reservation request message sent by the wireless communications unit further includes: navigation route information, a resource reservation quantity, and effective time of resource reservation.

A fourth aspect provides a network server, including:

a processor, configured to predict a next access point that is to be reached by a user; and

a transceiver, configured to send resource reservation designating information to the access point, so that the access point reserves a resource for the user according to the resource reservation designating information.

In a first possible implementation manner of the fourth aspect, the transceiver is further configured to obtain a resource reservation request message sent by the user, where the resource reservation request message includes location information; and

the processor is further configured to predict, according to the location information obtained by the transceiver, the next access point that is to be reached by the user.

With reference to the fourth aspect or the first possible implementation manner of the fourth aspect, in a second possible implementation manner, the transceiver is further configured to obtain information about a navigation path and a motion status that are of the user.

With reference to the fourth aspect or the first or the second possible implementation manner of the fourth aspect, in a third possible implementation manner, the processor is further configured to: when the transceiver receives the resource reservation request message, determine a priority of the user; and when it is determined, according to a busy/idle state of the resource and the priority of the user, to reserve the resource for the user, predict the next access point that is to be reached by the user.

With reference to the fourth aspect or the first, the second, or the third possible implementation manner of the fourth aspect, in a fourth possible implementation manner, the resource reservation request message received by the transceiver further includes: navigation route information, a resource reservation quantity, and effective time of resource reservation.

With reference to the fourth aspect or the first, the second, the third, or the fourth possible implementation manner of the fourth aspect, in a fifth possible implementation manner, the resource reservation designating information sent by the transceiver includes: a user identifier and a priority of resource reservation.

A fifth aspect provides an access point, including:

a receiver, configured to receive resource reservation designating information, sent by a network server, for reserving a resource for a user; and

a processor, configured to reserve the resource for the user according to the resource reservation designating information; and when a network resource is congested, smoothly remove some users from a network service or reduce bandwidth use of some users.

In a first possible implementation manner of the fifth aspect, the resource reservation designating information received by the receiver includes: a user identifier and a priority of resource reservation.

With reference to the fifth aspect or the first possible implementation manner of the fifth aspect, in a second possible implementation manner, the receiver is further configured to receive a handover request of the user; and

the processor is further configured to: when the receiver receives the handover request, determine that the resource is reserved for the user and allocate the resource reserved for the user to the user.

A sixth aspect provides a user resource reservation method, including:

predicting a next access point that is to be reached by a user; and

sending resource reservation designating information to the access point, so that the access point reserves a resource for the user according to the resource reservation designating information.

In a first possible implementation manner of the sixth aspect, the predicting a next access point that is to be reached by a user includes:

obtaining a resource reservation request message sent by the user, where the resource reservation request message includes location information; and

predicting, according to the location information, the next access point that is to be reached by the user.

With reference to the sixth aspect or the first possible implementation manner of the sixth aspect, in a second possible implementation manner, the method further includes:

obtaining information about a navigation path and a motion status that are of the user.

With reference to the sixth aspect or the first or the second possible implementation manner of the sixth aspect, in a third possible implementation manner, the method further includes:

determining a priority of the user when the resource reservation request message is obtained;

determining, according to a busy/idle state of the resource and the priority of the user, to reserve a resource for the user; and

when it is determined to reserve the resource for the user, predicting the next access point that is to be reached by the user.

With reference to the sixth aspect or the first, the second, or the third possible implementation manner of the sixth aspect, in a fourth possible implementation manner, the resource reservation request message further includes: navigation route information, a resource reservation quantity, and effective time of resource reservation.

With reference to the sixth aspect or the first, the second, the third, or the fourth possible implementation manner of the sixth aspect, in a fifth possible implementation manner, the resource reservation designating information includes: a user identifier and a priority of resource reservation.

A seventh aspect provides a user resource reservation method, including:

receiving user resource reservation designating information; and

reserving a resource for the user according to the user resource reservation designating information; and when a network resource is congested, smoothly removing some users from a network service or reducing bandwidth use of some users.

In a first possible implementation manner of the seventh aspect, the resource reservation designating information includes: a user identifier and a priority of resource reservation.

With reference to the seventh aspect or the first possible implementation manner of the seventh aspect, in a second possible implementation manner, the method further includes:

receiving a handover request of the user; and

if the resource is reserved for the user, allocating, according to the handover request of the user, the resource reserved for the user to the user.

An eighth aspect provides a user resource reservation method, including:

obtaining start-end location information of navigation and current location information of a user; and

sending the start-end location information of the navigation and the current location information of the user to a network server, so that the network server sequentially instructs, according to the start-end location information of the navigation and the current location information of the user, a next access point on a navigation path to reserve a resource for the user.

In a first possible implementation manner of the eighth aspect, the method further includes:

before navigation for the user, sending a resource reservation request message to the network server, where the resource reservation request message includes the start-end location information of the navigation; and

receiving a resource reservation acknowledgement response message that is fed back by the network server.

With reference to the eighth aspect or the first possible implementation manner of the eighth aspect, in a second possible implementation manner, the resource reservation request message further includes: navigation route information, a resource reservation quantity, and effective time of resource reservation.

It can be learned from the foregoing technical solutions that in the embodiments of the present disclosure, a next access point that is to be reached by a user is predicted and the access point is instructed to reserve a resource for the user, that is, a next access point is instructed in advance to reserve an appropriate resource for the user, so that the user can be successfully handed over to a network when initiating a handover request, and a probability of successful handover of the user increases, thereby improving user experience.

### BRIEF DESCRIPTION OF DRAWINGS

To describe the technical solutions in the embodiments of the present disclosure more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a user resource reservation apparatus according to an embodiment of the present disclosure;

FIG. 2 is another schematic structural diagram of a user resource reservation apparatus according to an embodiment of the present disclosure;

FIG. 3 is another schematic structural diagram of a user resource reservation apparatus according to an embodiment of the present disclosure;

FIG. 4 is another schematic structural diagram of a user resource reservation apparatus according to an embodiment of the present disclosure;

FIG. 4A is another schematic structural diagram of a user resource reservation apparatus according to an embodiment of the present disclosure;

FIG. 5 is a schematic structural diagram of a network server according to an embodiment of the present disclosure;

FIG. 6 is a schematic structural diagram of an access point according to an embodiment of the present disclosure;

FIG. 7 is a schematic structural diagram of a user resource reservation apparatus according to an embodiment of the present disclosure;

FIG. 8 is a flowchart of a user resource reservation method according to an embodiment of the present disclosure;

FIG. 9 is another flowchart of a user resource reservation method according to an embodiment of the present disclosure;

FIG. 10 is another flowchart of a user resource reservation method according to an embodiment of the present disclosure;

FIG. 11 is another flowchart of a user resource reservation method according to an embodiment of the present disclosure; and

FIG. 12A and FIG. 12B are a flowchart of an application instance according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

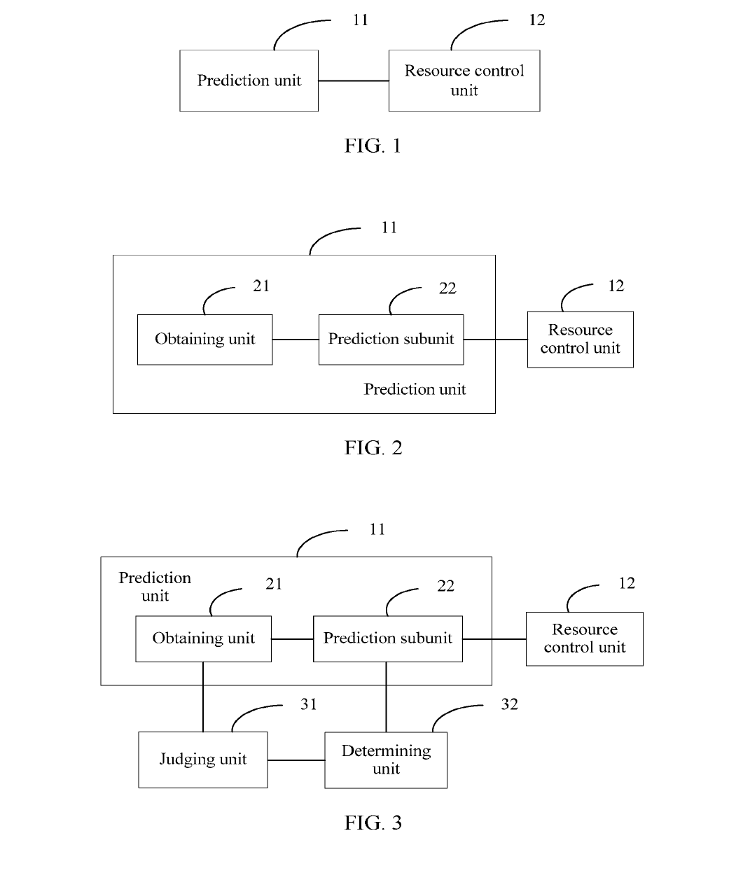

Refer to FIG. 1. FIG. 1 is a schematic structural diagram of a user resource reservation apparatus according to an embodiment of the present disclosure. The apparatus includes a prediction unit 11 and a resource control unit 12.

The prediction unit 11 is configured to predict a next access point that is to be reached by a user.

In this embodiment, a network server may periodically obtain a current location status of the user, and predict next one or more access points that are to be reached by the user. It should be noted that, when multiple access points are predicted, prediction continues until one access point is predicted.

The resource control unit 12 is configured to send resource reservation designating information to the access point, so that the access point reserves a resource for the user according to the resource reservation designating information.

In another embodiment, when a newly-predicted access point is different from the access point performing last resource reservation, the resource reservation designating information is sent to a new access point, and the new access point is instructed to reserve a designated resource for the user according to the resource reservation designating information.

In this embodiment, to avoid that the predicted access point is frequently changed in some cases, causing a reservation instruction message to be sent multiple times, delayed acknowledgement may be performed. For example, if new access points of two predictions within two consecutive prediction periods are the same and are different from the access point that is instructed to perform last resource reservation, a reservation instruction message is sent to the new access points. In addition, a resource control unit may further send a reservation resource release message to a former access point that has reserved the resource. Certainly, it is not limited thereto.

The resource reservation designating information may include a user identifier and a priority of resource reservation, and may further include a resource reservation quantity and/or effective time of resource reservation. Certainly, it is not limited thereto. The resource reservation designating information may further include another parameter according to a requirement, which is not limited in this embodiment.

The access point in this embodiment may be a base station device in a wireless mobile communications network, may be an AP device in a wireless local area network WLAN, or may be another similar wireless network device, which is not limited in this embodiment.

In this embodiment of the present disclosure, a next access point that is to be reached by a user is predicted and the access point is instructed to reserve a resource for the user, that is, a next access point is instructed in advance to reserve an appropriate resource for the user, so that the user can be successfully handed over to a network when initiating a handover request, and a probability of successful handover of the user increases, thereby improving user experience.

Optionally, in another embodiment, which is based on the foregoing embodiment, the prediction unit is further configured to: obtain a resource reservation request message sent by the user, where the resource reservation request message includes location information; and predict, according to the location information, the next access point that is to be reached by the user.

Further refer to FIG. 2. FIG. 2 is another schematic structural diagram of a user resource reservation apparatus according to an embodiment of the present disclosure. This embodiment is based on the embodiment in FIG. 1, where the prediction unit 11 includes an obtaining unit 21 and a prediction subunit 22.

The obtaining unit 21 is configured to obtain current location information of a user or a resource reservation request message sent by the user, where the resource reservation request message includes location information; in this embodiment, the location information may be information such as a place, but it is not limited thereto.

In this embodiment, in a case, the obtaining unit 21 may obtain the current location information of the user in a moving state. Certainly, further, when the current location information of the user is obtained, information about a navigation path of the user and/or information about a motion status of the user may further be obtained. For example, the information about the motion status may include a motion speed, a motion direction, or the like. For example, the current location information of the user that is sent by an in-vehicle navigation terminal is obtained. It should be noted that, when the user does not move, obtained locations are the same. Obtaining may not be performed, a quantity of times for obtaining is reduced, an obtaining period increases, and so on.

In another case, the obtaining unit 21 receives a resource reservation request message sent by the user, where the resource reservation request message may include a place, and may further include navigation route information, a resource reservation quantity, and/or effective time of resource reservation. For example, the user requests a network side to reserve bandwidth of a stadium, and for another example, the user requests the network side to reserve a resource of the stadium at seven o'clock to eight o'clock in the evening. For another example, the user requests to reserve a 2 Mbps communication resource on a first tier of Beijing-Shanghai expressway from a current moment. However, it is not limited thereto.

Optionally, before sending the resource reservation request message, the user may first send, to the network side, a request for requesting to reserve the resource. If the network side can reserve the resource for the user, the network side sends, to the user, a response that allows the user to request to reserve the resource. After receiving the response that is sent by the network side and that allows the user to request to reserve the resource, the user sends the resource reservation request message to the network side.

The prediction subunit 22 is configured to predict, according to the location information or the resource reservation request message, the next access point that is to be reached by the user.

In this embodiment, the prediction subunit 22 may accurately predict, according to the current location, an access point of a next station of the user, and instruct the access point to reserve the resource for the user in advance; or

the prediction subunit 22 may determine, according to a place in the resource reservation request message, an access point in a network to which the place belongs, and instruct the access point to reserve a resource in the designated time period for the user in advance.

In this embodiment of the present disclosure, a network side may predict, according to obtained current location information of a user or when a resource reservation request message sent by a user is received, a next access point that is to be reached by the user, and instruct the access point to reserve a resource for the user, that is, instruct the next access point in advance to reserve an appropriate resource for the user, so that when the user is handed over, the resource allocated and reserved for the user is used, thereby improving a handover success rate and a response speed, and improving user experience.

Further refer to FIG. 3. FIG. 3 is another schematic structural diagram of a user resource reservation apparatus according to an embodiment of the present disclosure. This embodiment is based on the embodiment in FIG. 2, where the apparatus further includes a judging unit 31 and a determining unit 32.

The judging unit 31 is configured to determine a priority of the user when the obtaining unit 21 obtains the resource reservation request message.

When the obtaining unit 21 receives the resource reservation request message, the judging unit 31 determines whether the user has permission to reserve a resource. A determining manner is that the judging unit 31 first determines the priority of the user or a user level, and may further determine a payment status of the user. A process of determining the priority of the user, the user level, or the payment status is a technology well known by a person skilled in the art, and details are not described herein.

The determining unit 32 is configured to determine, according to a busy/idle state of the resource and the priority of the user that is determined by the judging unit 31, to reserve a resource for the user.

When the resource is idle, the determining unit 32 may sequentially reserve the resource for the user according to the priority; and when the resource is insufficient (that is, congested), the determining unit 32 may preferentially determine to reserve a resource for a user of a high priority, and refuse to reserve a resource for a user of a low priority, and the like. Alternatively, the determining unit 32 determines to reserve some resources for the user of the low priority.

The prediction subunit 22 is further configured to: when the determining unit 32 determines to reserve the resource for the user, predict the next access point that is to be reached by the user.

The prediction subunit 22 predicts, according to a decision of the determining unit 32, the next access point that is to be reached by the user. For example, if the determining unit 32 determines to reserve a resource for a user of a high priority, the prediction subunit 22 predicts a next access point that is to be reached by the user of the high priority; if the determining unit 32 determines, according to the priority, to sequentially reserve the resource for the user, the prediction subunit 22 sequentially predicts next access points that are to be reached by a user of a high priority and a user of a low priority.

Optionally, the user resource reservation apparatus may be integrated into a network server, may be independently deployed, or may be integrated into another network device, which is not limited in this embodiment.

In this embodiment of the present disclosure, when receiving the resource reservation request message, a network side determines, according to an idle/busy state of a resource and a priority of a user, whether to reserve a resource for the user; and when it is determined to reserve the resource for the user, a next access point that is to be reached by the user is predicted, and the access point is instructed to reserve the resource for the user, so that the user is successfully handed over to a network, and a probability of successful handover of the user to the network increases, thereby improving user experience.

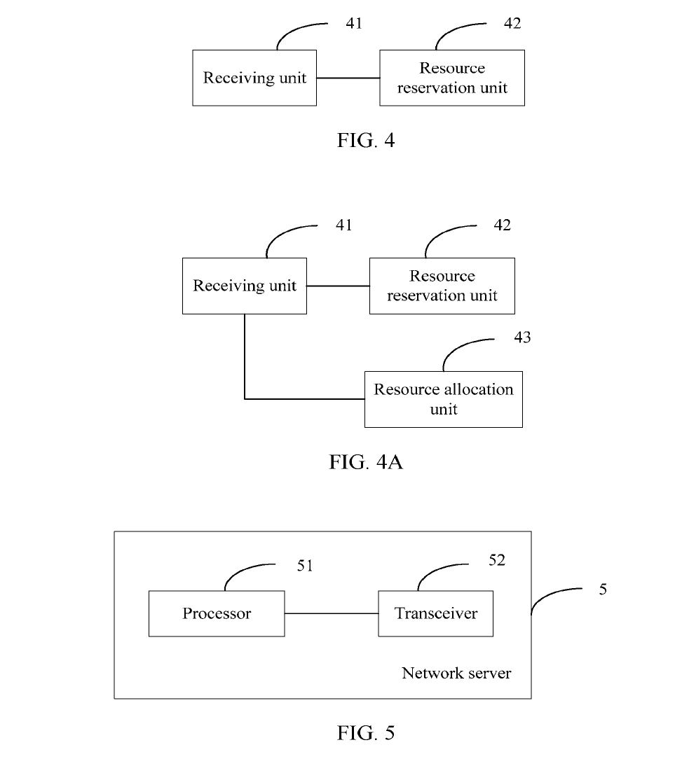

Further refer to FIG. 4. FIG. 4 is another schematic structural diagram of a user resource reservation apparatus according to an embodiment of the present disclosure. The apparatus includes a receiving unit 41 and a resource reservation unit 42.

The receiving unit 41 is configured to receive resource reservation designating information of a user.

In this step, resource reservation designating information, sent by a network server or another network element, for reserving a resource for the user may be received.

The resource reservation designating information includes a user identifier and a priority of resource reservation, and may further include a resource reservation quantity and/or effective time of resource reservation.

In this embodiment, the user is an important user, a user of a high priority, or the like.

The resource reservation unit 42 is configured to reserve a resource for the user according to the user resource reservation designating information; and when a network resource is congested, smoothly remove some users from a network service or reduce bandwidth used by some users.

When the network resource is congested, some common or low priority users are smoothly removed from the network service first, or bandwidth used by some common or low priority users is reduced.

It should be noted that, the resource reserved by an access point is a size of network transmission bandwidth, which refers to a transmission service whose network service quality may be ensured. It is generally referred to as a guaranteed bit rate (GBR, Guaranteed bit rate) in a communications system. When the user for whom the resource is reserved does not hand over to a network of an access point, the access point may determine itself to temporarily use a GBR bandwidth resource reserved for the user to serve a non-GBR service of another user, but cannot use the GBR bandwidth resource for a GBR service of the another user.

In this embodiment, the resource may be reserved for the user in the following several manners, which is not limited thereto.

(1) The resource is reserved for the user according to the priority of the user, that is, the priority of reservation is divided into at least two levels: a high priority and a low priority, and finer subdivision may further be performed. When the resource of the access point is insufficient, if the access point finds that the reservation is reservation of a high priority, a required bandwidth resource needs to be vacated for the user; if the reservation is reservation of a low priority, the access point may refuse a resource reservation request.

(2) The resource is reserved for the user within effective time of resource reservation, that is, when the access point reserves the resource for the user only within a designated effective time range, if the user is not accessed after an effective time expires, the access point should abandon a reservation action. The effective time is not an effective time for a service of the user in the network of the access point. When the user hands over to the access point in a time period that is determined by the effective time, the access point formally allocates a reserved resource to the user, and a role of the effective time ends.

(3) When the network resource is congested, some common or low priority users are smoothly removed from the network service, or the bandwidth used by these users is reduced, so that the resource is reserved for the user; that is, in an access point that is severely congested, after receiving a bandwidth resource reservation instruction, the access point may make preparations in advance to smoothly remove some users from the network service, or gradually reduce a bandwidth resource of these users, so that appropriate bandwidth is vacated for a user who has performed reservation or appointment to use.

(4) When the network resource is congested, if a handover request of the user is received and the user has requested for resource reservation, the resource is allocated to the user; that is, in the access point that is severely congested, when receiving the handover request of the user, the access point determines whether the user has performed bandwidth resource reservation. If the user has performed the bandwidth resource reservation, the access point allocates the reserved bandwidth resource to the user, and accepts the handover request. If the user has not performed the bandwidth resource reservation, the access point may refuse the handover request according to a service type of the user, or may allocate only a small part of the resource required by the user, so as to support a partial network function.

(5) When multiple users request resource reservation and resources are insufficient, the resources are reserved for the users according to priorities of the multiple users from high to low. That is, when multiple users have performed bandwidth resource reservation, if bandwidth resources are in shortage, a system may dispatch the bandwidth resources according to information such as priority levels of the users.

However, it is not limited thereto, and another manner of reserving the resource for the user may further be included, which is not described one by one in this embodiment.

The user resource reservation apparatus may be integrated into an access point, where the access point may be a base station device in a wireless mobile communications network, may be an AP device in a wireless local area network WLAN, or may be another similar wireless network device, which is not limited in this embodiment.

In this embodiment of the present disclosure, when resource reservation designating information is received, if a network resource is insufficient, a service is provided for a mobile user according to a level, and a network bandwidth service with quality assurance is provided for an important user. For a common user, when an assured network service cannot be provided, a smooth transition may be ensured, preventing the user from feeling a sudden change of network transmission bandwidth. This not only ensures that the important user can be successfully handed over to a network, but also ensures the smooth transition of the common user.

Further refer to FIG. 4A. FIG. 4A is another schematic structural diagram of a user resource reservation apparatus according to an embodiment of the present disclosure. On the basis of the foregoing embodiment in FIG. 4, the apparatus may further include a resource allocation unit 43.

The receiving unit 41 is further configured to receive a handover request of the user.

The resource allocation unit 43 is configured to: when a resource is reserved for the user, allocate, according to the handover request received by the receiving unit 41, the resource reserved for the user to the user.

In this embodiment, when the user needs to perform a cell handover in a moving process, a serving access point forwards the handover request of the user to a target access point. When receiving the handover request, the target access point first determines whether the user has requested resource reservation; if the user has requested resource reservation, allocates the resource reserved for the user to the user; or otherwise, if a current resource is congested and when the handover request is accepted, allocates a partial resource to the user; or otherwise, refuses the handover request of the user, that is, refuses handover of the user.

In this embodiment of the present disclosure, when the resource reservation designating information for reserving the resource for the user is received, if the network resource is congested, the resource may still be reserved for the user according to the resource reservation designating information, thereby ensuring that an important user can be successfully handed over to a network, and improving user satisfaction.

Further refer to FIG. 5. FIG. 5 is a schematic structural diagram of a network server according to an embodiment of the present disclosure. The network server 5 includes a processor 51 and a transceiver 52.

The processor 51 is configured to predict a next access point that is to be reached by a user.

The transceiver 52 is configured to send resource reservation designating information to the access point, so that the access point reserves a resource for the user according to the resource reservation designating information.

The resource reservation designating information includes a user identifier and a priority of resource reservation, and may further include a resource reservation quantity and/or effective time of resource reservation. However, it is not limited thereto, and another parameter may further be adaptively included, which is not limited in this embodiment.

Optionally, in another embodiment, the transceiver 52 is further configured to obtain a resource reservation request message sent by the user, where the resource reservation request message includes location information.

The processor 51 is further configured to: when the transceiver 52 obtains the resource reservation request message sent by the user, predict a next access point that is to be reached by the user.

The resource reservation request message may further include a resource reservation quantity; but it is not limited thereto, and another parameter may further be adaptively included, which is not limited in this embodiment.

Optionally, in another embodiment, the transceiver 52 is further configured to: when obtaining current location information of the user, obtain information about a navigation path of the user and/or information about a motion status of the user.

Optionally, in another embodiment, the processor 51 is further configured to: when the transceiver 52 receives the resource reservation request message, determine a priority of the user; and when it is determined, according to a busy/idle state of the resource and the priority of the user, to reserve a resource for the user, predict the next access point that is to be reached by the user.

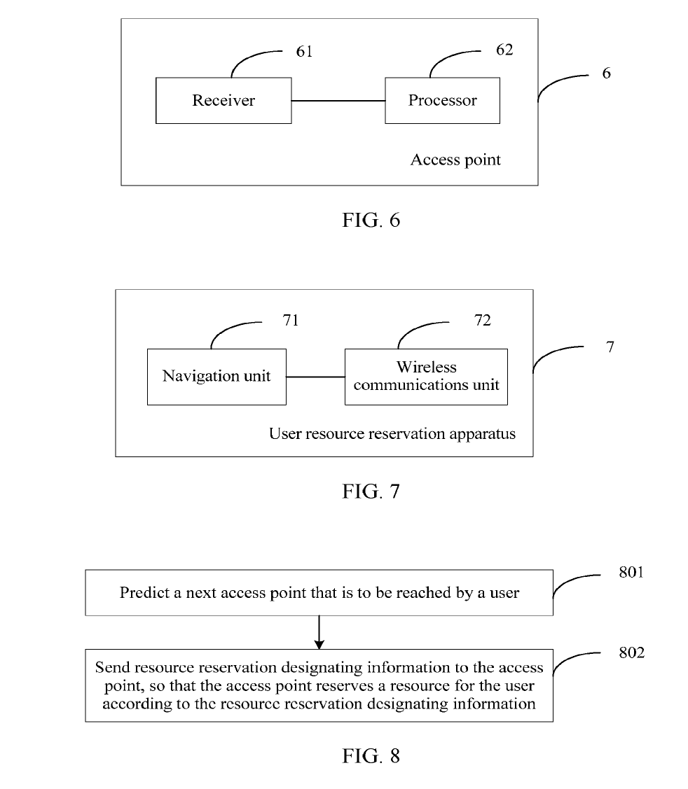

Further refer to FIG. 6. FIG. 6 is a schematic structural diagram of an access point according to an embodiment of the present disclosure. The access point 6 includes a receiver 61 and a processor 62.

The receiver 61 is configured to receive resource reservation designating information, sent by a network server, for reserving a resource for a user.

The resource reservation designating information includes a user identifier and a priority of resource reservation, and may further include a resource reservation quantity and/or effective time of resource reservation. However, it is not limited thereto, and another parameter may further be adaptively included, which is not limited in this embodiment.

The processor 62 is configured to reserve the resource for the user according to the resource reservation designating information; and when a network resource is congested, smoothly remove some users from a network service or reduce bandwidth used by some users.

When the network resource is congested, some common or low priority users are smoothly removed from the network service first, or bandwidth use of some common or low priority users is reduced.

Optionally, in another embodiment, the receiver 61 is further configured to receive a handover request of the user.

The processor 62 is further configured to: when the receiver receives the handover request and if the resource is reserved for the user, allocate the resource reserved for the user to the user.

Optionally, in another embodiment, the processor 62 is further configured to: when it is determined that the user does not request resource reservation, and if a current resource is congested and the handover request is accepted, allocate a small part of the resource to the user.

Further refer to FIG. 7. FIG. 7 is a schematic structural diagram of a user resource reservation apparatus according to an embodiment of the present disclosure. The user resource reservation apparatus 7 includes a navigation unit 71 and a wireless communications unit 72.

The navigation unit 71 is configured to obtain start-end location information of navigation and current location information of a user.

The wireless communications unit 72 is configured to send, to a network server, the start-end location information of the navigation and the current location information of the user that are obtained by the navigation unit, so that the network server instructs, according to the start-end location information of the navigation and the current location information of the user, an access point on a navigation path to reserve a resource for the user.

In this embodiment, after a start-end location of the navigation is selected, a navigation system may be driven according to a selected path. If this path information is notified to a mobile communications network, the network may predict in advance that the user accesses the network from which access point at a next moment, and instructs a new access point to get ready a required resource in advance.

Generally, any mobile user may send a request to the network server by using terminal software, and inform a network device of a travelling path and a required bandwidth resource that are of the mobile user. In addition, an important mobile user may indirectly initiate a resource reservation request to the network server by using a secretary station, so as to implement network resource reservation.

Optionally, in another embodiment, the wireless communications unit is further configured to: before navigation for the user, send a resource reservation request message to the network server, where the resource reservation request message includes the start-end location information of the navigation; and receive a resource reservation acknowledgement response message that is fed back by the network server. Further, the resource reservation request message may further include: navigation route information, a resource reservation quantity, and/or effective time of resource reservation. However, it is not limited thereto.

This embodiment may be applied to an in-vehicle navigation system, or may be applied to another mobile terminal. The following uses the in-vehicle navigation system as an example to describe a manner of requesting bandwidth resource reservation or appointment, but it is not limited to the following several manners:

1. Request by using the in-vehicle navigation system. The in-vehicle navigation system may include a navigation subsystem (that is, a navigation unit), a communications subsystem (that is, a wireless communications unit), and the like. When the user sets a navigation path by using the navigation subsystem, the navigation path may be sent to the network server, and the network server sequentially instructs, according to path information, an access point device on a path route to reserve a bandwidth resource for the user. The communications subsystem is a communications relay system, which implements a communication pipeline between a wireless network and an in-vehicle service subsystem, and may have a function of providing network communication for multiple in-vehicle user terminals. The in-vehicle service subsystem may include the following types:

(1) Aback-row liquid crystal display of a sedan car is an in-vehicle service subsystem. A back-row passenger in the sedan car may watch a program such as a video on the back-row liquid crystal display, and content of the program is transmitted by using the communications subsystem.

(2) An in-vehicle service subsystem is installed on each seat of a coach bus, and content of a program is transmitted by using the communications subsystem. A user may use the in-vehicle service subsystem to play a favorite program on demand.

(3) A taxi may also provide this kind of service to implement differentiation of the service and show competitiveness.

2. Request by using an intelligent terminal of a user. The intelligent terminal integrates a resource reservation client, and may be integrated with navigation software. By using the client, a route, start-end time, and the like of an access point that needs to be reserved or appointed may be set.

3. Request by using a customer service client, that is, a reservation resource request is sent. For an important user, a secretary may make a call to a customer service center, and the customer service center submits navigation path information, or reserve a transmission resource in a specific time period in a specific area.

In this embodiment of the present disclosure, a service is provided for a mobile user according to a level. Even if a network is severely congested, a network bandwidth service with quality assurance may still be provided for an important user. However, for a common user, when an assured network service cannot be provided, relatively smooth transition is implemented, avoiding a sudden change of network transmission bandwidth.

Based on an implementation process of the foregoing apparatus, an embodiment of the present disclosure further provides a flowchart of a user resource reservation method, where the method includes:

Step 801. Predict a next access point that is to be reached by a user.

In this embodiment, a network server may periodically obtain a current location status of the user, and predict next one or more access points that are to be reached by the user. If multiple access points are detected, detection may continue until one access point is predicted.

Step 802. Send resource reservation designating information to the access point, so that the access point reserves a resource for the user according to the resource reservation designating information.

When a newly-predicted access point is different from the access point performing last resource reservation, the resource reservation designating information is sent to a new access point, and the new access point is instructed to reserve a designated resource for the user according to the resource reservation designating information. To avoid that the predicted access point is frequently changed in some cases, causing a reservation instruction message to be sent multiple times, delayed acknowledgement may be performed. If new access points of two predictions within two consecutive prediction periods are the same and are different from the access point that is instructed to perform last resource reservation, a reservation instruction message is sent to the new access points. In addition, a resource control unit may further send a reservation resource release message to a former access point that has reserved the resource.

The resource reservation designating information may include a user identifier and a priority of resource reservation, and may further include a resource reservation quantity and/or effective time of resource reservation. Certainly, it is not limited thereto. The resource reservation designating information may further include another parameter according to a requirement, which is not limited in this embodiment.

In this embodiment of the present disclosure, a next access point that is to be reached by a user is predicted and the access point is instructed to reserve a resource for the user, that is, a next access point is instructed in advance to reserve an appropriate resource for the user, so that the user is successfully handed over to a network, and a probability of successful handover of the user to the network increases, thereby improving user experience.

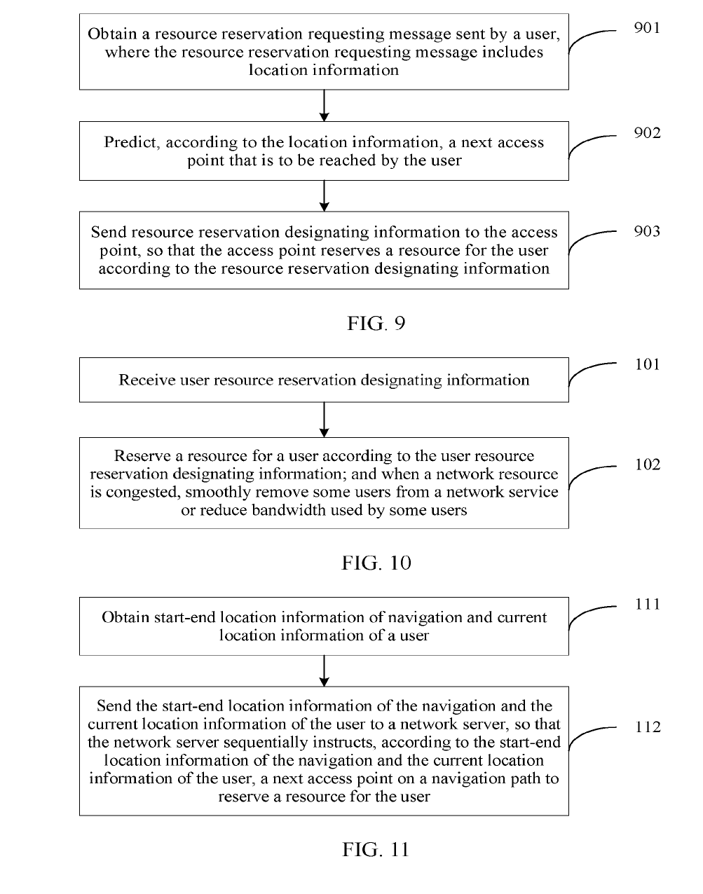

Further refer to FIG. 9. FIG. 9 is another flowchart of a user resource reservation method according to an embodiment of the present disclosure. The method includes:

Step 901. Obtain a resource reservation request message sent by a user, where the resource reservation request message includes location information.

In this embodiment, step 901 may further be obtaining current location information of the user.

The resource reservation request message may further include the location information, and certainly, may further include navigation route information, a resource reservation quantity, and/or effective time of resource reservation. However, it is not limited thereto.

Step 902. Predict, according to the location information, a next access point that is to be reached by the user.

Certainly, in this embodiment, the next access point that is to be reached by the user may also be predicted according to the location information. Certainly, the next access point that is to be reached by the user may also be predicted with reference to the navigation route information, the resource reservation quantity, and/or time of the resource reservation that are included in the resource reservation request message.

Step 903. Send resource reservation designating information to the access point, so that the access point reserves a resource for the user according to the resource reservation designating information.

The resource reservation designating information may include a user identifier and a priority of resource reservation, and may further include a resource reservation quantity and/or effective time of resource reservation, but it is not limited thereto.

In this embodiment, step 901 and step 902 are specific steps of step 801 in FIG. 8.

Optionally, before sending the resource reservation request message, the user may first send, to a network side, a request for inquiring whether the resource can be reserved. If the network side can reserve the resource for the user, a response indicating that the resource can be reserved is sent to the user. After receiving, from the network side, the response indicating that the resource can be reserved, the user sends the resource reservation request message to the network side.

Optionally, in another embodiment, which is based on the foregoing embodiment, the method may further include: obtaining information about a navigation path of the user and/or information about a motion status of the user. Optionally, the information about the navigation path of the user and/or the information about the motion status of the user may also be obtained when the current location information of the user is obtained, which is not limited in this embodiment.

Optionally, in another embodiment, which is based on the foregoing embodiment, before prediction, the method may further include: when the obtaining the resource reservation request message, determining a priority of the user; determining, according to a busy/idle state of the resource and/or the priority of the user, whether to reserve the resource for the user; and when it is determined to reserve the resource for the user, predicting the next access point that is to be reached by the user.

In this embodiment of the present disclosure, when receiving the resource reservation request message, a network side determines, according to an idle/busy state of a resource and a priority of a user, whether to reserve a resource for the user; and when it is determined to reserve the resource for the user, a next access point that is to be reached by the user is predicted, and the access point is instructed to reserve the resource for the user, so that the user is successfully handed over to a network, and a probability of successful handover of the user to the network increases, thereby improving user experience.

Further refer to FIG. 10. FIG. 10 is another flowchart of a user resource reservation method according to an embodiment of the present disclosure. The method includes:

Step 101. Receive user resource reservation designating information.

Step 101 may be receiving the user resource reservation designating information sent by a network server, or may be receiving the user resource reservation designating information sent by another network, which is not limited in this embodiment.

Step 102. Reserve a resource for the user according to the user resource reservation designating information; and when a network resource is congested, smoothly remove some users from a network service or reduce bandwidth used by some users.

The resource reservation designating information includes a user identifier and a priority of resource reservation, and may further include a resource reservation quantity and/or effective time of resource reservation.

Optionally, in another embodiment, the method may further include: receiving a handover request of the user; and if the resource is reserved for the user, allocating, according to the handover request of the user, the resource reserved for the user to the user.

That is, when the handover request of the user is received, it is first determined whether the resource is reserved for the user. If the resource is reserved for the user, the resource reserved for the user is allocated to the user; if the resource is not reserved for the user, according to a congestion status of the resource, a handover of the user may be refused, a partial resource is allocated to the user, or the like.

Further refer to FIG. 11. FIG. 11 is another flowchart of a user resource reservation method according to an embodiment of the present disclosure. The method includes:

Step 111. Obtain start-end location information of navigation and current location information of a user.

Step 112. Send the start-end location information of the navigation and the current location information of the user to a network server, so that the network server sequentially instructs, according to the start-end location information of the navigation and the current location information of the user, a next access point on a navigation path to reserve a resource for the user.

Optionally, in another embodiment, which is based on the foregoing embodiment, the method may further include: before navigation for the user, sending a resource reservation request message to the network server, where the resource reservation request message includes start-end location information of navigation; and receiving a resource reservation acknowledgement response message that is fed back by the network server.

The resource reservation request message further includes: navigation route information, a resource reservation quantity, and/or effective time of resource reservation.

In this embodiment of the present disclosure, a service is provided for a mobile user according to a level. Even if a network is severely congested, a network bandwidth service with quality assurance may still be provided for an important user. However, for a common user, when an assured network service cannot be provided, relatively smooth transition is implemented, avoiding a sudden change of network transmission bandwidth.

To facilitate understanding of a person skilled in the art, the following gives description by using a specific application instance.

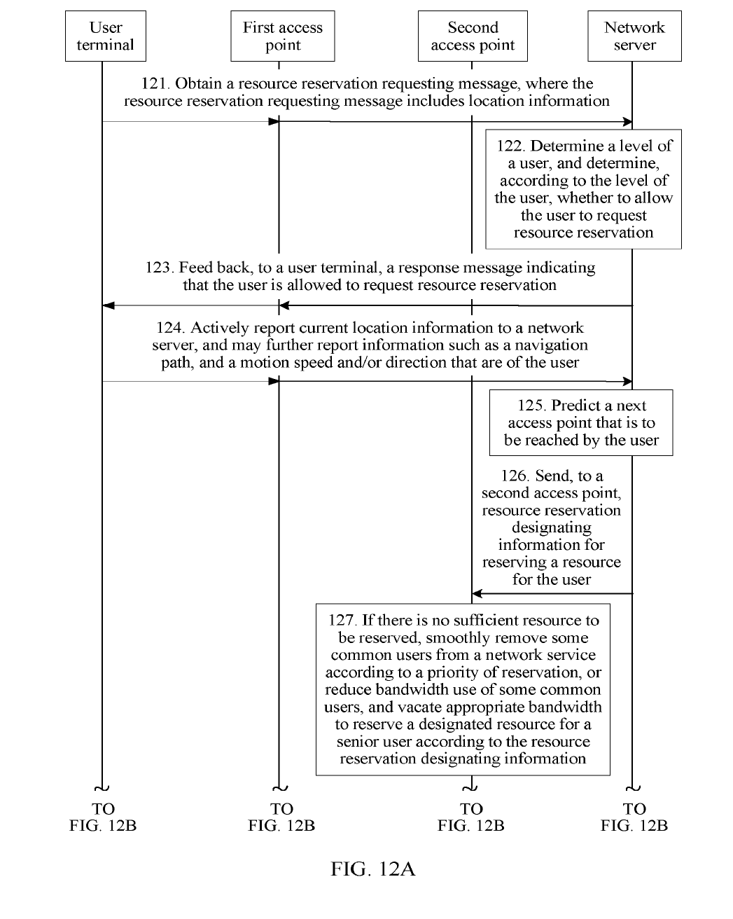

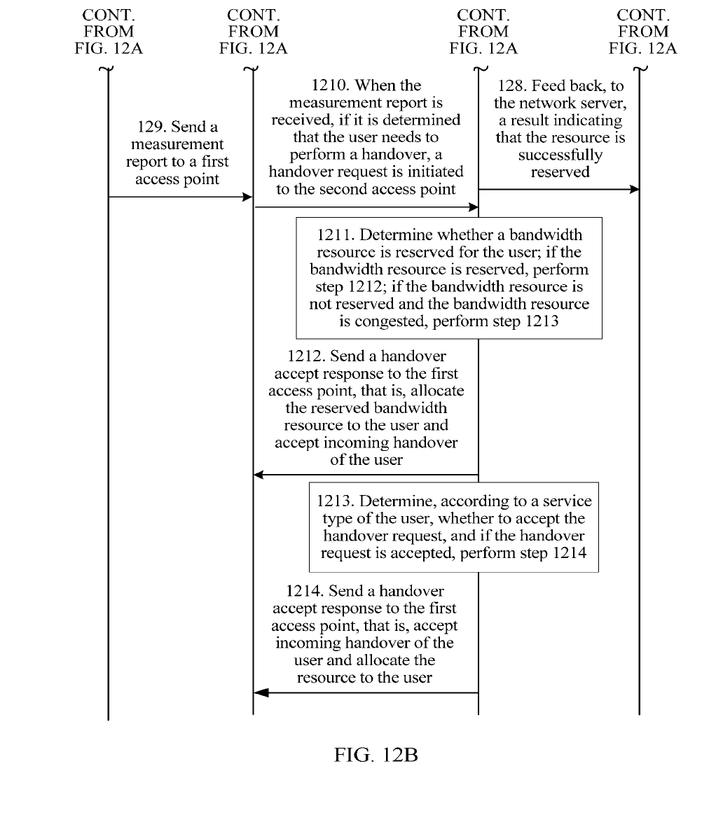

Further refer to FIG. 12A and FIG. 12B. FIG. 12A and FIG. 12B are a flowchart of an application instance according to an embodiment of the present disclosure.

This embodiment includes a user, a first access point, a second access point, and a network server. An implementation process of the application instance includes:

Step 121. The user sends a resource reservation request message to the network server, where the resource reservation request message includes location information, and may further include navigation route information, a resource reservation quantity, and/or effective time of resource reservation.

In this embodiment, a navigation path may be sent to the network server by using a navigation subsystem, to request resource reservation; certainly, resource reservation may also be requested by using another system, which is not limited in this embodiment.

Step 122. When receiving the resource reservation request message sent by a terminal of the user, the network server determines a level of the user; determines, according to the level of the user, whether to allow the user to request resource reservation; and if the user is allowed to request resource reservation, performs step 123.

In this embodiment, when the level of the user is determined, information such as a payment status of the user may be further determined. Then, it is determined, according to the level of the user and the payment status, whether to allow the user to request resource reservation.

Determining the level of the user and the payment status is a technology well known by a person skilled in the art, and details are not described herein.

Step 123. The network server feeds back, to the user, a response message indicating that the user is allowed to request resource reservation.

In this embodiment, if the network server allows the user to request resource reservation, the response message includes information indicating that the user is allowed to request resource reservation; and if the user is not allowed to request resource reservation, the response message includes information indicating that the user is not allowed to request resource reservation.

In this embodiment, an example in which the user is allowed to request resource reservation is used.

Step 124. After receiving the response message indicating that a request for resource reservation is allowed, the user actively reports current location information to the network server, and may further report information such as a navigation path, and a motion speed and/or direction that are of the user.

Certainly, in this step, the network server may also actively obtain the current location information of the user, and may further obtain the information such as the navigation path, and the motion speed and/or direction that are of the user. When obtaining the current location information of the user, the network server may directly send a request to the user terminal, or may send a request to a device that has a function of user terminal location positioning in another network.

Step 125. The network server predicts a next access point that is to be reached by the user.

In this embodiment, the next access point that is to be reached by the user may be predicted according to the current location information of the user; further, the next access point that is to be reached by the user may further be comprehensively predicted according to the information such as a current location, the navigation path, and the motion speed and/or direction.

In this embodiment, an example in which the next access point that is to be reached by the user is a second access point is used, but it is not limited thereto.

Step 126. The network server sends, to the second access point, resource reservation designating information for reserving the resource for the user, so that the second access point reserves the resource for the user according to the resource reservation designating information.

The resource reservation designating information may include a user identifier and a priority of resource reservation, and may further include a resource reservation quantity and/or effective time of resource reservation.

Step 127. When the second access point receives the resource reservation designating information and if there is no sufficient resource to be reserved, smoothly remove some common users from a network service according to a priority of reservation, or reduce bandwidth use of some common users, and vacate appropriate bandwidth to reserve a designated resource for a senior user according to the resource reservation designating information.

Step 128. The second access point feeds back, to the network server, a result indicating that the resource is successfully reserved.

Certainly, if the resource is successfully reserved, the result includes information indicating that the resource is successfully reserved; if the resource is unsuccessfully reserved, the result includes information indicating that the resource is unsuccessfully reserved.

Step 129. The user sends a measurement report to a first access point.

In a moving process of the user, the measurement report is sent in real time or periodically to an access point that serves the user.

Step 1210. When the first access point receives the measurement report, if it is determined that the user needs to perform a handover, a handover request is initiated to the second access point.

Step 1211. The second access point determines whether a bandwidth resource is reserved for the user; if the bandwidth resource is reserved, perform step 1212; and if the bandwidth resource is not reserved and the bandwidth resource is congested, perform step 1213.

Step 1212. The second access point sends a handover accept response to the first access point, that is, allocates the reserved bandwidth resource to the user and accepts handover of the user.

Step 1213. The second access point determines, according to a service type of the user, whether to accept the handover request, and if the handover request is accepted, performs step 1214.

Step 1214. The second access point sends a handover accept response to the first access point, that is, accepts handover of the user and allocates the resource to the user.

In this embodiment, when a network resource is not congested, the resource required by the user should be allocated. When a network is congested, adaptive allocation, refusal, or the like may be performed according to a situation. This embodiment does not differentiate whether some resources or all resources are allocated to the user.

Certainly, in this embodiment, reserving the resource for the user according to the resource reservation designating information may further include the following several cases:

when the network is not congested, the resource is reserved for the user according to a priority of the user; and/or

when the network is not congested, the resource is reserved for the user within effective time designated by the user; and/or

when the network resource is congested, some common or low priority users are smoothly removed from a network service, or bandwidth used by some common or low priority users is reduced, so that the resource is reserved for the user of a high priority; and/or

when the network resource is congested, if a handover request of the user is received and the user has requested resource reservation, the reserved resource is allocated to the user; if the user does not request resource reservation, the handover request may be accepted and a small part of the resource is allocated to the user, or the handover request of the user may be refused; and/or

when multiple users request resource reservation and the resource is insufficient, the resource is reserved for the users according to priorities of the multiple users from high to low.

The terms used in the embodiments of the present disclosure are merely for the purpose of illustrating specific embodiments, and are not intended to limit the present disclosure. The terms “a”, “said” and “the” of singular forms used in the embodiments and the appended claims of the present disclosure are also intended to include plural forms, unless otherwise specified in the context clearly. It should also be understood that, the term “and/or” used herein indicates and includes any or all possible combinations of one or more associated listed items.

It should be understood that although terms “first”, “second”, “third” and the like may be used in the embodiments of the present disclosure to describe various information, the information is not limited by the terms. These terms are only used to differentiate information of a same type. For example, without departing from the scope of the embodiments of the present disclosure, first information may also be referred to as second information, and similarly the second information may also be referred to as the first information. Depending on the context, for example, words “if” used herein may be explained as “while” or “when” or “in response to determining”.

Based on the foregoing descriptions of the embodiments, a person skilled in the art may clearly understand that the present disclosure may be implemented by software in addition to a necessary universal hardware platform or by hardware only. In most circumstances, the former is a preferred implementation manner. Based on such an understanding, the technical solutions of the present disclosure essentially or the part contributing to the prior art may be implemented in a form of a software product. The software product is stored in a storage medium, such as a ROM/RAM, a hard disk, or an optical disc, and includes several instructions for instructing a computer device (which may be a personal computer, a server, a network device, or the like) to perform the methods described in the embodiments or some parts of the embodiments of the present disclosure.

The foregoing descriptions are merely exemplary implementation manners of the present disclosure. It should be noted that a person of ordinary skill in the art may make several improvements or polishing without departing from the principle of the present disclosure and the improvements or polishing shall fall within the protection scope of the present disclosure.

What is claimed is:

1. A network server, comprising:
a processor, configured to predict a next access point in a mobile communication network that is to be accessed by a mobile device belonging to a user; and
a transceiver, configured to send resource reservation designating information to the next access point, so that the next access point reserves a resource according to the resource reservation designating information for the user to conduct mobile communication via the next access point.

2. The network server according to claim 1, wherein
the transceiver is further configured to receive a resource reservation request message sent by the mobile device, wherein the resource reservation request message comprises location information of the mobile device; and
the processor is further configured to predict, according to the location information, the next access point that is to be accessed by the mobile device.

3. The network server according to claim 2, wherein
the transceiver is further configured to receive information of a navigation path and a motion status of the mobile device.

4. The network server according to claim 2, wherein
the processor is further configured to: when the transceiver receives the resource reservation request message, determine a priority of the mobile communication by the user; determine whether to reserve the resource for the user to conduct the mobile communication according to a busy/idle state of the resource and the priority; and when to reserve the resource for the user is determined, predict the next access point that is to be accessed by the mobile device.

5. The network server according to claim 2, wherein the resource reservation request message received by the transceiver further comprises: navigation route information, a resource reservation quantity, and effective time of resource reservation.

6. The network server according to claim 1, wherein the resource reservation designating information sent by the transceiver comprises: a user identifier and a priority of resource reservation.

7. An access point in a mobile communication network, comprising:
a receiver, configured to receive resource reservation designating information, sent by a network server, for reserving a resource for a user to conduct mobile communication using a mobile device; and
a processor, configured to reserve the resource for the user according to the resource reservation designating information; and when the resource is congested, free a portion of the resource that is occupied by one or more other users.

8. The access point according to claim 7, wherein the resource reservation designating information received by the receiver comprises: a user identifier and a priority of resource reservation.

9. The access point according to claim 7, wherein
the receiver is further configured to receive a handover request for the user to conduct the mobile communication via the access point; and
the processor is further configured to: when the receiver receives the handover request and when the resource is reserved for the user, allocate the resource reserved for the user to the user.

10. A method for user resource reservation, comprising:
predicting, by a network server in a mobile communication network, a next access point in the mobile communication network that is to be accessed by a mobile device belonging to a user; and
sending, by the network server, resource reservation designating information to the next access point, so that the next access point reserves a resource for the user to conduct mobile communication via the next access point according to the resource reservation designating information.

11. The method according to claim 10, wherein predicting, by the network server in the mobile communication network, the next access point in the mobile communication network that is to be accessed by the mobile device belonging to the user comprises:
obtaining a resource reservation request message sent by the mobile device, wherein the resource reservation request message comprises location information of the mobile device; and
predicting, according to the location information, the next access point that is to be accessed by the mobile device.

12. The method according to claim 11, further comprising:
receiving information of a navigation path and a motion status of the mobile device.

13. The method according to claim 11, further comprising:
determining, by the network server, a priority of the mobile communication by the user when the resource reservation request message is received;
determining, by the network server according to a busy/idle state of the resource and the priority, whether to reserve a resource for the user; and
when to reserve the resource for the user is determined, predicting the next access point that is to be accessed by the user.

14. The method according to claim 11, wherein the resource reservation request message further comprises: navigation route information, a resource reservation quantity, and effective time of resource reservation.

15. The method according to claim 10, wherein the resource reservation designating information comprises: a user identifier and a priority of resource reservation.

16. A method for user resource reservation, comprising:
receiving, by an access point in a mobile communication network, user resource reservation designating information for reserving a resource for a user to use a mobile device to conduct mobile communication via the access point; and
reserving the resource for the user according to the user resource reservation designating information; and when the resource is congested, free a portion of the resource that is occupied by one or more other users.

17. The method according to claim 16, wherein the resource reservation designating information comprises: a user identifier and a priority of resource reservation.

18. The method according to claim 17, further comprising:
receiving, by the access point, a handover request of the user to conduct the mobile communication via the access point; and
when the resource is reserved for the user, allocating, by the access point, according to the handover request of the user, the resource reserved for the user to the user.

19. A method for user resource reservation, comprising:
obtaining, by a mobile device, navigation information for a user who uses the mobile device to conduct mobile communication in a trip, and current location information of the mobile device, the navigation information including a starting location and a terminating location of the trip; and
sending, by the mobile device, the navigation information and the current location information of the mobile device to a network server in a mobile communication network, so that the network server instructs, according to the navigation information and the current location information of the user, a next access point to be accessed by the mobile device on a navigation path to reserve a resource for the user.

20. The method according to claim 19, further comprising:
before starting a navigation for the user according to the navigation information, sending a resource reservation request message to the network server, wherein the resource reservation request message comprises the navigation information; and
receiving, by the mobile device, a resource reservation acknowledgement response message that is fed back by the network server.
